(19) United States
(12) Patent Application Publication
(10) Pub. No.: US 2005/0141634 A1
(43) Pub. Date: Jun. 30, 2005

(54) [APPARATUS AND METHOD FOR DETECTING AND COMPENSATING CURRENT OFFSET]

(76) Inventor: Ang-Sheng Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,428

(22) Filed: Mar. 2, 2004

(30) Foreign Application Priority Data
Dec. 26, 2003 (TW) 92136981

(51) Int. Cl. H04L 25/00

(52) U.S. Cl. 375/295

(57) ABSTRACT

A quadrature modulator and a transmitter capable of detecting and reducing a current offset are provided. The quadrature modulator comprises a base band transconductance for converting a voltage signal into a current signal and a switching pair for modulating the current signal. A current sink is further coupled after the base band transconductance for detecting a current offset of the current signal. When the current sink is enabled to detect the current offset of the transmitter within a predetermined time interval, the switching pair is disabled, and after the predetermined time interval lapses, the current sink is disabled and the switching pair is enabled.

### CROSS REFERENCE TO RELATED APPLICATIONS

This application claims the priority benefit of Taiwan application serial no. 92136981, filed Dec. 26, 2003.

### BACKGROUND OF INVENTION

1. Field of the Invention

The present invention is generally related to a transmitter capable of detecting and reducing a current offset. More particularly, the present invention relates to a method and an apparatus capable of detecting and compensating a current offset before the RF band.

2. Description of the Related Art

Wireless communication is without a doubt a popular research and commercial topic. Typically, wireless communication starts from a transmitter processing input signals to signals that then transmit “wirelessly” to a receiver. The receiver then re-processes the signals received and converted the signals back to the input signals. One of the major challenges in the wireless communication technologies today is the quality of transmission. In the other words, transmission without a quality loss has becoming an area-of-interest for research. The quality loss can be from the distortion and the interference in the transmitter, receiver or in the air. The present invention focuses on carrier leakage in the transmitter stage.

FIG. 1A schematically illustrates the elements of a conventional transmitter. Referring to FIG. 1A, an in-phase signal I and a quadrature-phase signal Q are sent to a first digital-to-analog converter 110a and a second digital-to-analog converter 110b respectively. Next, the in-phase signal I and the quadrature-phase signal Q are sent to a first base band filter 112a and a second base band filter 112b respectively, before sending to a quadrature modulators 100. FIG. 1B schematically illustrates the elements of a conventional transmitter with a Gilbert-Cell quadrature modulator. Referring to FIG. 1B, the quadrature modulator 100 mainly includes base band transconductance stages 130a and 130b and switching pairs 132a and 132b. Now, the in-phase signal I and the quadrature-phase signal Q are sent to the base band transconductance stages 130a and 130b and then the switching pairs 132a and 132b respectively before sending to the radio frequency amplifier 118 for wireless transmission.

It is noticeable from the above that during such path, there is inevitable signal quality loss in the transmission and signal conversions. The in-phase signal I and the quadrature-phase signal Q are first converted into analog signals, and then filtered by the base band filters 112a, 112b. The filtered in-phase signal I and the quadrature-phase signal Q are then transmitted to the base band transconductance stages 130a, 130b of the quadrature modulator 100, at which voltage signals are converted into current signals. However, mismatch in the base band stages 110a, 110b, 112a, 112b, 130a, 130 causes a current-offset before the modulator switching pairs 132a, 132b, and therefore, a carrier leakage is generated. The carrier leakage has a great impact on the signal quality received in the receiver, and also has an adverse affect to the transmission quality of the transmitter. Several mechanisms aim at detecting and correcting the carrier leakage during the transmission and signal conversions have been implemented. Two of the mechanisms are described in the following paragraphs.

FIG. 2 schematically illustrates a conventional transmitter with a synchronous detector as a carrier leakage detector. Referring to FIG. 2, a radio frequency (RF) peak detector 270 is inserted and electrically coupled between the radio frequency amplifier 218 and the quadrature modulator 200. The RF peak detector 270 detects a carrier leakage and feeds back to the quadrature modulator 200 for correction. Although the design is able to detect a carrier leakage of a transmitter, but it also creates several problems. First, the input capacitors of the MOS transistors of the radio frequency peak detector 270 create problems in manufacturing and cost and impedance tuning required when a change in radio frequency is made in the transmitter. In addition, when a new manufacturing process, such as a 0.18μ process, the RF peak detector 270 has to be redesigned for meeting new requirements, which is not very convenient. Next, it also affects a circuitry of the quadrature modulator 200 during normal operation especially in high frequency. Moreover, detection in high frequency not only affects a performance of the circuitry, but also increases high capacitive loading of an oscillator output, which is undesired.

FIG. 3 schematically illustrates another conventional transmitter with voltage comparator as a DC offset detector. Referring to FIG. 3, a first comparator 381 is inserted and electrically coupled to the conversion mixer 314 of the quadrature modulator 300. As shown in the FIG. 3, an input signal I(t) is sent to the first comparator 381 then to a state machine 380 before sending back to the input signal I(t) for correction. Although the DC offset detector does not affect the performance when operated in base band frequency, it only detects a base band DC offset before the quadrature modulator 300 and ignores the transconductance stage mismatch of the quadrature modulator 300. In addition, according to this method, although the DC offset can be compensated in advance, but in some circumstances, the input impedances of the quadrature modulator 340 for the I- and the Q-phase signals might be slightly different, which also misjudges the current offset and thus causes the carrier leakage. As a result, this method is also too complicated and undesired.

### SUMMARY OF INVENTION

In order to solve the conventional drawbacks, it is an objective of the present invention to provide a method and apparatus thereof for detecting a base band current offset before transmission to radio frequency (RF) band. Therefore, the present invention avoids the previous problems in using capacitors for detection in high frequency that increases cost, affects performance of a circuit and increases capacitive loading of the local oscillator. The method also detects the current offset during the transconductance stage mismatch of the quadrature modulator.

Another objective of the present invention is to provide a method to reduce the transmission carrier leakage after a current offset is detected.

Another objective of the present invention is to provide an apparatus for detecting a base band current offset before transmission to radio frequency (RF) band and reducing the transmission carrier leakage after a current offset is detected.

In order to meet the objectives of the present invention, the present invention provides a quadrature modulator. The quadrature modulator comprises a base band transconductance for converting a voltage signal into a current signal and a switching pair for modulating the current signal. A current sink is further coupled between the base band transconductance and a base band transconductance, for detecting a current offset of the current signal. When the current sink is enabled to detect the current offset of the transmitter within a predetermined time interval, the switching pair is disabled, and after the predetermined time interval lapses, the current sink is disabled and the switching pair is enabled.

The invention further provides a transmitter capable of reducing the current offset before transmitted to the RF band. The transmitter comprises a digital-to-analog converter module for receiving voltage signals; a base band filter module, coupled to the analog converters module; a quadrature module coupled to the base band filter module, for converting filtered voltage signals into current signals and then modulating the current signals; a current sink module, coupled to the quadrature module and enabled for intercepting the current signals to detect a current offset before the current signals are modulated; an offset compensation module, coupled between the current sink module and one of the digital-to-analog converter module, the base band filter module and the quadrature module, for compensating the current offset when the current sink module is enabled; and a radio frequency amplifier, coupled to the quadrature module, for amplifying the modulated current signals and then transmitting amplified signals to an antenna. In this way, the current offset can be detected and compensated before transmitted to the RF band.

In the aforementioned transmitter, the quadrature module can further comprises a base band transconductance and a switching pair. The current sink module is arranged therebetween, and when the current sink module is enabled, the switching pair is disabled. When the current sink module is enabled within a predetermined time interval, and the switching pair is enabled after the predetermined time interval lapses.

In one embodiment of the invention, the offset compensation module can be coupled between the current sink module and one of the digital-to-analog converter module, the base band filter module and the base band transconductance.

In one embodiment of the invention, the offset compensation module can be a voltage offset compensator, for example. In this manner, the voltage offset compensator can further comprise a current-to voltage converter coupled to the current sink module, and a direct current (DC) offset minimum loop coupled to the current-to voltage converter for compensating a voltage offset within the predetermined time interval. Moreover, the DC offset minimum loop is further coupled to one of the digital-to-analog converter module, the base band filter module and the base band transconductance.

The present invention further provides a method for detecting and compensating a current offset for a transmitter. The transmitter has a quadrature modulator including a base band transconductance stage, a switching pair and a current sink arranged therebetween. The method comprises steps of enabling the transmitter; turning on the current sink and turning off the switching pair for a predetermined time interval; compensating the current offset within the predetermined time interval; and turning off the current sink and turning on the switching pair after the predetermined time interval lapses. The method detects a carrier leakage before a switching pair of the transmitter. Thus, the current leakage during a transconductance stage mismatch of a quadrature modulator of the transmitter is detected.

The present invention further provides a method for detecting and compensating a current offset for a transmitter, comprising steps of enabling the transmitter; receiving voltage signals and converting the voltage signals into current signals; intercepting a current offset of the current signals before the current signals are modulated and transmitted; and compensating the current offset within the predetermined time interval. As a result, the current offset can be detected and compensated before a switching pair of the transmitter. Therefore, the current offset during a transconductance stage mismatch of a quadrature modulator of the transmitter is detected and compensated, so that the carrier leakage is also reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A schematically illustrates the elements of a conventional transmitter.

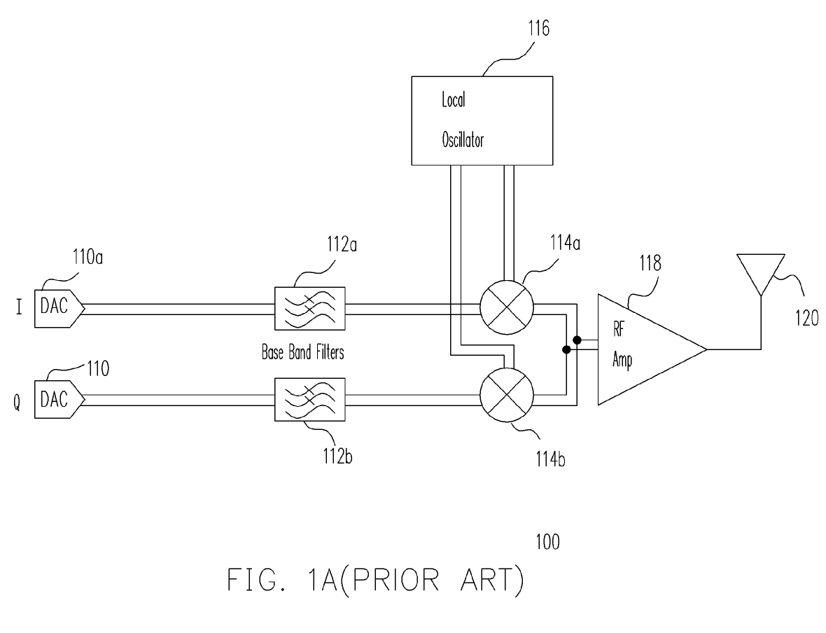

FIG. 1B schematically illustrates the elements of a conventional transmitter with Gilbert-Cell quadrature modulator.

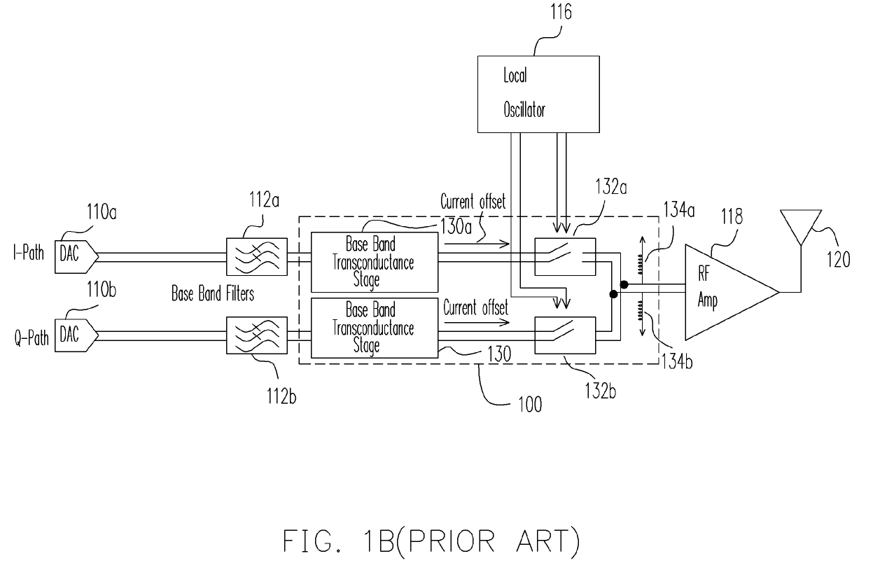

FIG. 2 schematically illustrates a conventional transmitter with a synchronous detector as a carrier leakage detector.

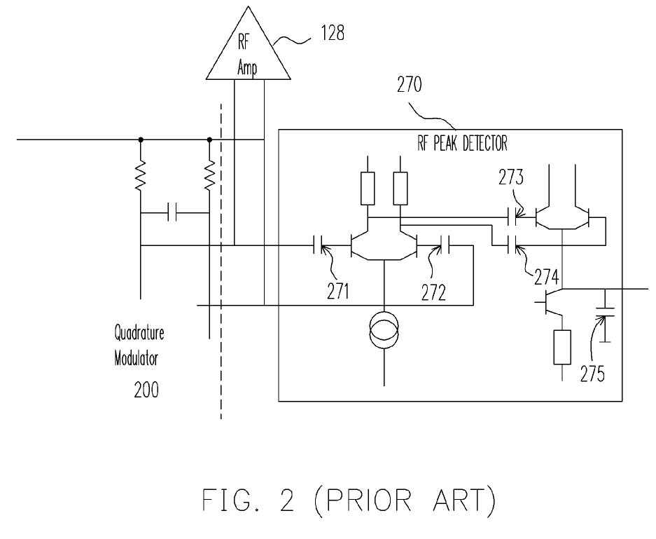

FIG. 3 schematically illustrates a conventional transmitter with voltage comparator as a DC offset detector.

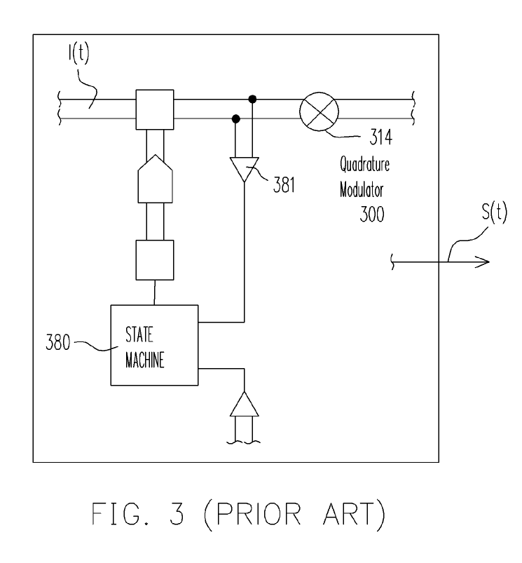

FIG. 4A schematically shows a transmitter with a means for current sink and an auto calibration loop as one preferred embodiment of the present invention.

FIG. 4B shows a timing diagram or a timing control sequence of control signals for the current sink and the switching pair.

FIG. 5 shows an exemplary circuit of the partial transmitter in FIG. 4A.

FIG. 6 shows a flow chart of detecting and calibrating the current offset according to the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

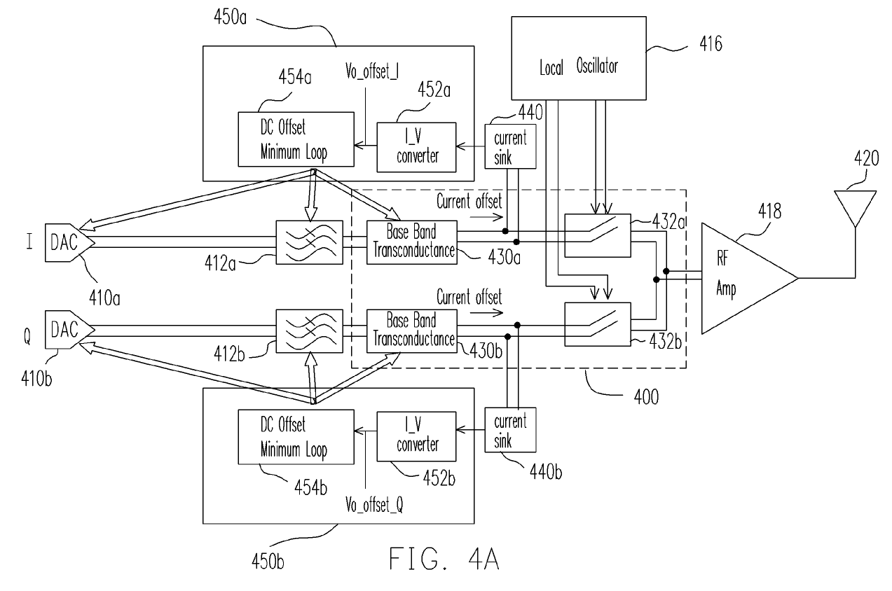

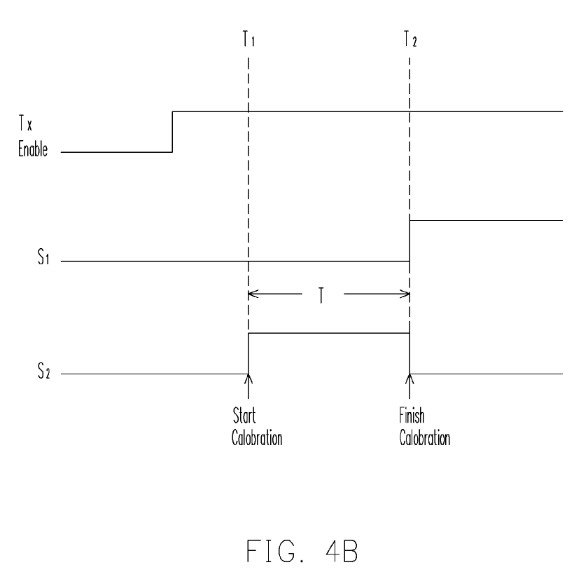

FIG. 4A schematically shows a transmitter with a means for current sink as one preferred embodiment of the present invention. Referring to FIG. 4A, a transmitter for wireless communication includes a quadrature modulator 400, digital-to-analog converters 410a and 410b, base band filters 412a and 412b, an oscillator 416, a radio frequency (RF) amplifier 418 and an antenna 420. In addition, an in-phase signal I and a quadrature-phase signal Q are input to the transmitter.

Referring to FIG. 4A, current sinks 440a and 440b are inserted and electrically coupled between the base band transconductance stage 430a and the switching pair 432a, and the base band transconductance stage 430a and the switching pair 432b respectively. In which, the current sinks 440a and 440b are able to detect a current offset due to the mismatch in the base band filters 412a, 412b.

According to one feature of the present invention, when the current sinks 440a, 440b are in operation, the switching pairs 432a, 432b are open and disabled. Namely, before signals are transmitted to the RF amplifier 418, the signals are intercepted by the current sinks 440a, 440b without being transmitted to the corresponding switching pairs 432a, 432b. After the signals are intercepted, the levels of the current offsets are respectively detected by the current sinks 440a, 440b, and then the current off sets are compensated. After the current sinks 440a, 440b operate for a predetermined time T, the current sinks 440a, 440b are turned of and the switching pairs 432a, 432b are close, so that the compensated signals are transmitted to the RF amplifier 418 through the switching pairs 432a, 432b. During the working period of the current sinks 440a, 440b, the current offset is compensated to a minimum or an acceptable value. If the current offset is too large to be reduced, only several times of current-offset calibration are performed within the predetermined time T.

FIG. 4B shows a timing diagram or a timing control sequence of control signals for the current sink and the switching pair. Referring to FIG. 4B, when a transmitter enable signal (TX enable) is asserted, a control signal S1 for enabling the switching pairs is sent by delaying a predetermined time T at a time point T2. A control signal S2 for enabling the current sinks 440a, 440b is asserted at a time point T1 just after the TX enable signal is asserted, and then is de-asserted at the time point T2. The time interval between the time points T1 and T2 is an operation period for the current sinks 430a, 430b. In the conventional way, as the TX enable signal is asserted, the control signal S1 is sent just after the TX enable signal is asserted, so as to enable the switching pairs 432a, 432b for modulating the signals to be transmitted. However, according to the present invention, the switching pairs 432a, 432b are not immediately enabled, and in stead, the current sinks 430a, 430b are enabled prior to the switching pairs 432a, 432b. In this way, before the signals are transmitted to the RF amplifier 418 through the switching pairs 432a, 432b, the current offset can be detected and calibrated. As a result, after the time interval T lapses, either the current offset is calibrated to the acceptable value or the current offset is too large to be reduced, the current sinks 430a, 430b are disabled and the switching pairs 432a, 432b are enabled at the time point T2. In other words, the current offset is calibrated to the minimum or the acceptable value before the signals are transmitted to the switching pairs 432a, 432b. Therefore, according to the present invention, the problem caused by the current offset can be easily solved by merely using the current sinks 430a, 430b.

Next, the calibration for the current offset is described in detail as follows. Again referring to FIG. 4A, the transmitter further includes offset compensation devices 450a, 450b capable of performing a carrier leakage calibration loop. The offset compensation device 450a (450b) is coupled between the current sink 430a (430b) and one of the DAC 410a (410b), the base band filter 412a (412b) and the base band transconductance stage 430a (430b). One can design the offset compensation device according to requirements. For example, if the current offset is mainly caused by the base band filter 412a, the offset compensation device 450a can be arranged between the current sink 430a and the base band filter 412a. The offset compensation device 450a is discussed below, and the related description of the offset compensation device 450b is omitted because the offset compensation devices 450a, 450b function in the same way.

Referring to FIG. 4A, the offset compensation device 450a further comprises a current-to-voltage (I-V) converter 452a and a DC offset minimum loop 454a, which are connected in turn. The I-V converter 452a is coupled to the current sink 430a for converting the current offset into a voltage offset. The DC offset minimum loop 454a receives the voltage offset and perform a voltage offset calibration on the voltage offset. The compensated or calibrated result is then feedback to the DAC 410a, the base band filter 412a or the base band transconductance stage 430a. The offset compensation device 450a together with the current sink 440a are activated to perform the detection and calibration function with the time interval T (see FIG. 4B). The result is the current offset before the switching pair 432a and 432b is reduced and the carrier leakage is also reduced when the offset compensation devices 450a, 450b reduce the output voltage offset. When the output offset voltage (Vo_offset_I, Vo_offset_Q) is reduced by the injection compensation current or voltage, the current offset before the switching pairs of the quadrature modulator is also reduced and the carrier leakage is this reduced. The circuitry of the offset compensation devices 450a, 450b is only an example for describing the embodiment of the present invention, but not for limiting the scope of the present invention. For those skilled in the art, other modifications for the offset compensation devices 450a, 450b are still within the scope of the invention.

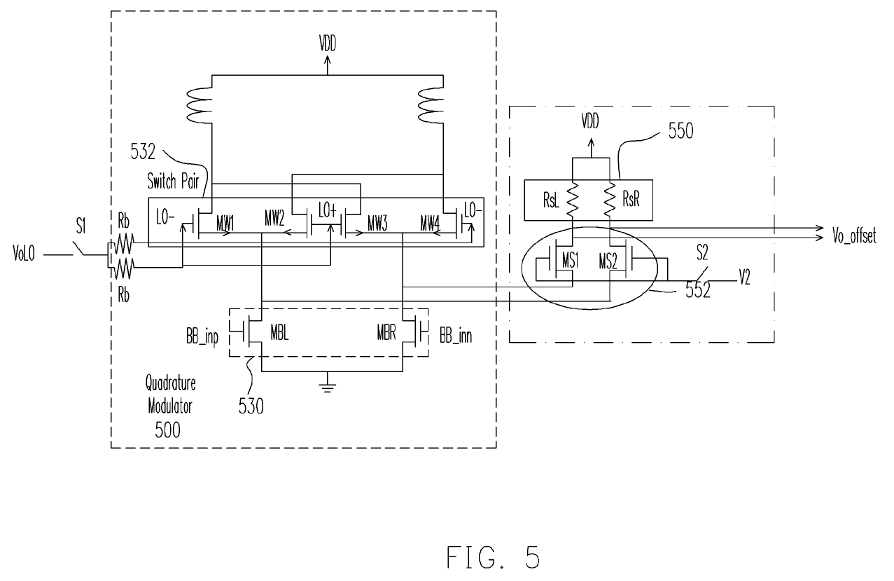

FIG. 5 shows an exemplary circuit including the switching pairs, the current sinks, the I-V converter. Referring to FIG. 5, the quadrature modulator comprises the switching pairs (MW1, MW2) and (MW3, MW4), the transconductance stages MBL, MBR. The current sinks comprises a transistor MS1 and a transistor MS2. The current-to-voltage converter comprises a matched resistor pair RsR and RsL.

Referring to both FIG. 4B and FIG. 5, the time control sequence turns off a switch S1 and turns on a switch S2. The switch S1 turns off the switching pairs (MW1, MW2) and (MW3, MW4), and the switch S2 turns on the current sinks MS1, MS2. Thus, in a calibration mode (S1 off and S2 on), a current signal in the MBL and MBR pass to the MS1 and MS2, and convert to a voltage signal on the RsL and RsR. The result is a current offset before the switching pair (MW1, MW2) and (MW3, MW4) is extracted and converted to a voltage offset. The calibration mode is operated within the time interval T. After the calibration mode is finished, the time control sequence returns to a normal operation mode, where the S1 turns on (the switching pairs (MW1, MW2) and (MW3, MW4) turn on) and S2 turns off (the current sinks MS1, MS2 turns off).

Moreover, although the current sink device 552 does not adapt the calibration actively, it does not affect the DC network in the normal operation mode (S1 on and S2 off). Furthermore it is unnecessary to use adaptive carrier leakage calibration in most applications. Thus, the present embodiment of the invention is able to resolve the current leakage during the transconductance stage mismatch of the quadrature modulator while not affecting high frequency performance.

Also referring to FIG. 5, a mismatch of the matched resistor pair RsL and RsR is, for example, below 0.1% in a modern integrated circuit process although the matched resistor pair RsL and RsR value variation can be very large. As another preferred embodiment of the present invention, the matched resistor pair RsL and RsR is made up of common centroid layout topology because the inherent performance of the common centroid layout topology is very suitable to convert a current mode signal to a voltage mode signal.

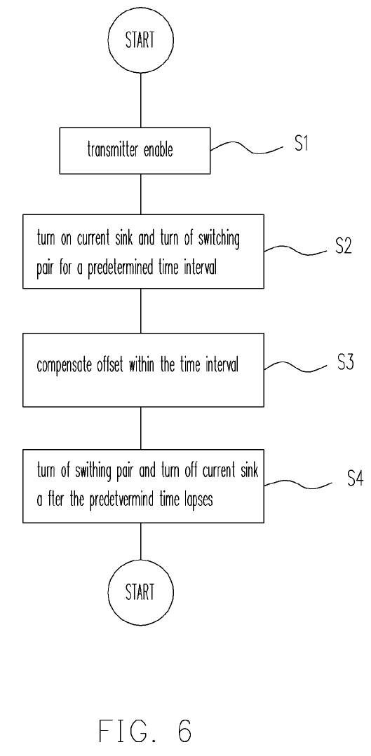

FIG. 6 shows a flow chart of detecting and calibrating the current offset according to the present invention. The transmitter comprises a quadrature modulator including a base band transconductance stage and a switching pair as shown in FIG. 4A, for example. A current sink is arranged between the base band transconductance stage and the switching pair. At Step S1, the transmitter is enabled and ready to perform a signal transmission. At step S2, as the transmitter is enabled, the switching pair is turned off for a predetermined time interval while the current sink is being turned on. At this time, the current offset is detected by the current sink. Then, the current offset is compensated within the predetermined time interval at Step S3. At Step S4, after the predetermined time interval lapses, the current sink is turned off and the switching pair is turned on. In this way, the current offset can be detected and reduced before the current signals are transmitted to the RF band. As a result, the carrier leakage can be reduced.

To summarize, the present invention provides a method and apparatus thereof capable of detecting and correcting a carrier leakage of a transmitter. The method avoids the previous problems from the capacitors, detection in high frequency and increase capacitive loading of the local oscillator. Rather, the method detects a carrier leakage before a switching pair of the transmitter. Thus, the current leakage during a transconductance stage mismatch of a quadrature modulator of the transmitter is detected. Moreover, the method provides an auto calibration loop after the current leakage is detected. The calibration loop includes a means for converting a current signal to a voltage signal. Moreover, the calibration loop can further include a looping for offsetting DC voltage signal for at least one of the base band transconductance stage of the quadrature modulator, a base band filter of the transmitter and a digital-to-analog converter of the transmitter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A quadrature modulator, comprising:
a base band transconductance, for converting a voltage signal into a current signal;
a switching pair for modulating the current signal;
a current sink, coupled between the base band transconductance and a base band transconductance, for detecting a current offset of the current signal, wherein when the current sink is enabled to detect the current offset of a transmitter within a predetermined time interval, the switching pair is disabled, and after the predetermined time interval lapses, the current sink is disabled and the switching pair is enabled.

2. A transmitter, comprising:
a digital-to-analog converter module for receiving voltage signals;
a base band filter module, coupled to the analog converters module;
a quadrature module coupled to the base band filter module, for converting filtered voltage signals into current signals and then modulating the current signals;
a current sink module, coupled to the quadrature module and enabled for intercepting the current signals to detect a current offset before the current signals are modulated;
an offset compensation module, coupled between the current sink module and one of the digital-to-analog converter module, the base band filter module and the quadrature module, for compensating the current offset when the current sink module is enabled; and
a radio frequency amplifier, coupled to the quadrature module, for amplifying the modulated current signals and then transmitting amplified signals to an antenna.

3. The transmitter of claim 2, wherein the quadrature module further a base band transconductance and a switching pair, and the current sink module is arranged therebetween, and when the current sink module is enabled, the switching pair is disabled.

4. The transmitter of claim 3, wherein when the current sink module is enabled within a predetermined time interval, and the switching pair is enabled after the predetermined time interval lapses.

5. The transmitter of claim 2, wherein offset compensation module is coupled between the current sink module and one of the digital-to-analog converter module, the base band filter module and the base band transconductance.

6. The transmitter of claim 1, wherein the offset compensation module is a voltage offset compensator.

7. The transmitter of claim 6, wherein the voltage offset compensator further comprises a current-to voltage converter coupled to the current sink module, and a direct current (DC) offset minimum loop coupled to the current-to voltage converter for compensating a voltage offset within the predetermined time interval.

8. The transmitter of claim 6, wherein the DC offset minimum loop is further coupled to one of the digital-to-analog converter module, the base band filter module and the base band transconductance.

9. A method for detecting and compensating a current offset for a transmitter, the transmitter having a quadrature modulator including a base band transconductance stage, a switching pair and a current sink arranged therebetween, the method comprising:
enabling the transmitter;
turning on the current sink and turning off the switching pair for a predetermined time interval;
compensating the current offset within the predetermined time interval; and
turning off the current sink and turning on the switching pair after the predetermined time interval lapses.

10. A method for detecting and compensating a current offset for a transmitter, comprising:
enabling the transmitter;
receiving voltage signals and converting the voltage signals into current signals;
intercepting a current offset of the current signals before the current signals are modulated and transmitted; and
compensating the current offset within the predetermined time interval.
